(19) United States
(12) Patent Application Publication
(10) Pub. No.: US 2015/0129119 A1
(43) Pub. Date: May 14, 2015

(54) METHOD OF CALCULATING THE PATHWAY OF RIGID STRIP OVER OBJECTS OF COMPLEX CURVATURE AND COVERING OBJECT SURFACE WITH FIBER STEERING

(71) Applicant: Yoldas Askan, Bedford (GB)

(72) Inventor: Yoldas Askan, Bedford (GB)

(21) Appl. No.: 14/485,651

(22) Filed: Sep. 12, 2014

Related U.S. Application Data
(60) Provisional application No. 61/865,568, filed on Aug. 13, 2013.

(51) Int. Cl. B32B 38/18

(52) U.S. Cl. CPC B32B 38/1866
USPC 156/212

(57) ABSTRACT

A method for strip draping fiber to form a composite using a complex 3D mould surface is disclosed. A strip pathway is calculated without any widthwise steer across fiber length, i.e. to demonstrate a strip natural pathway. Widthwise steering defined by natural bending of the strip to cover tool surface without gaps or overlaps between adjacent fibers is used. Fiber initial drape is adjusted in a direction to minimize steering of the strip. The method further comprises determination and reduction of local steer maxima that results from mould convolution and average out all the fiber steer over the mould surface.

### TECHNICAL FIELD

The invention relates to apparatus and methods for generating, for example in three dimensions, a surface contour representation of a tool generated by strips of material, such as carbon fiber, which covers the entire surface without defect.

### CROSS REFERENCE TO RELATED APPLICATIONS

(Not applicable).

### STATEMENT REGARDING FEDERALLY SPONSORED RESEARCH OR DEVELOPMENT

(Not applicable)

### BACKGROUND OF THE INVENTION

Rapid manufacturing plays an important role in the future of manufacturing industry. One leading technology is the automated positioning of carbon fiber strips over a tool/mandrel/mould surface via robotic arms first to cover the entire surface and then build up additional layers to create the composite structure. This process is called Automated fiber placement (AFP) or Automated tape laying (ATL) (www.compositesworld.com/articles/afpatl-design-to-manufacture-bridging-the-gap

More info at:

http://www.digplanet.com/wiki/Automated_fiber_placement: “Automated fiber placement (AFP) machines are a recent development of composite manufacturing technologies meant to increase rate and precision in the production of advanced composite parts. AFP machines place fiber reinforcements on moulds or mandrels in an automatic fashion and use a number of separate small width tows (typically 8 mm or less) of thermoset or thermoplastic pre-impregnated materials to form composite layups. This technology allows better precision and increased deposition rates when compared with experienced laminators but, while allowing for more complex layup geometries than Automated Tape Laying (ATL) it does not reach the same deposition rates.” Also: http://www.google.com/patents/US20110277935 The patent: http://www.google.com/patents/US20050236735 is simplistic and it is not tackling the 3D problem with 3D modeling. Compare the images on this patent with figures of this patent. Similarly, http://www.google.com/patents/US8052819 not doing what is needed.

### SUMMARY OF THE INVENTION

Generally, the invention relates to the fabrication of carbon fiber composite parts, such as automobile bodies, aircraft wings, turbine blades, and the like. Such carbon fiber fabrication techniques generally involve the use of a strip or ribbon form of very fine graphite fibers. During fabrication, the ribbon is passed through a resin bath. After passing through the resin bath, the fibers are applied to a tool or other form which defines the shape of the part being fabricated.

For example, a cylindrical pipe may be fabricated by winding a strip around a cylindrical form in helical configuration, with the right edge of one winding of the strip in a budding or slightly overlapped relationship to the left edge of the next winding. If the relationship is simply a budding, a pipe having a wall thickness equal to the thickness of the ribbon will be formed without any overlap. However, not all parts fabricated with carbon fibers are defined by a ribbon formed into a particular curve or set of curves. For example, a cone is a form which cannot be formed without stretching the right or left edge of a ribbon of graphite fibers.

Although the Automated fiber placement (AFP) manufacturing has been implemented in recent times, the noncompliance of fiber strip natural pathways on complex tool surface curvature has lead to defects in the composite structure. Such as over-steered and overstressed strips, gaps and/or overlaps between adjacent strips. In accordance with the invention, the method comprises of calculating exact pathways of rigid strips on tool surface and by using natural bending of the strips. The tool surface contour complexity produce sudden change in strip direction. The trade-off between natural bending of the strip which allows change of direction and strip natural drape pathway predominates the existence of gaps and overlaps. Therefore, the invention highlights on the importance of determining the strip natural drape pathway.

### BRIEF DESCRIPTION THE DRAWINGS

FIG. 1 illustrates widthwise natural bending of a strip (Rigid strip (B), Left steer (A) and Right steer (C)) permissible to cover surface tool surface.

FIG. 2 illustrates lengthwise natural bending of a strip (Rigid strip (B), Upward steer (A) and Downward steer (C)) permissible to cover surface tool surface.

FIG. 3 illustrates natural lengthwise bending (FIG. 1 (B) & FIG. 2(C))of a strip on an uniform rod.

FIG. 4 illustrates natural lengthwise bending (FIG. 1 (B) & FIG. 2(C))of a strip on an uniform rod with fiber drape orientation altered.

FIG. 5 illustrates constant widthwise right steer (FIG. 1 (C) & FIG. 2(C)) and natural lengthwise bending of a strip on an uniform rod.

FIG. 6 is an image a simple tool with carbon fiber strip arbitrarily positioned at certain drape direction on the tool surface.

FIG. 7 is an image showing the commencement of natural lengthwise draping over the tool surface. The strip change its direction over the tool surface according to the tool surface contour. Natural pathway of the fiber strip does not contain widthwise left or right steer.

FIG. 8 is an image showing the termination of natural draping at the object boundary. Full strip length has not been utilized. The image illustrates large gap between the drape start position and subsequent fiber visiting drape start point.

FIG. 9 illustrates a constant right steer applied to strip in order to close the gap at the drape start position.

FIG. 10 is an image showing the culmination of constant right steer draping with entire strip length contained within object boundary. As illustrated in the figure inset, constant steer does not eliminate gaps that occur following fiber passing the drape start point.

FIG. 11 illustrates variable steer draping that eliminates gaps or overlaps that would otherwise occur on the tool surface. Strip start orientation is a changeable parameter that can be used to minimize overall fiber steer. The strip length draped within tool surface boundary increases.

FIG. 12 illustrates fiber steer value increases as fiber strip is draped towards the narrow end of the cone. The fiber steer is known at all times and program uses the steer value to terminate draping when fiber steering reaches specified steer limit, usually defined by the fiber strength.

FIG. 13 shows a conical tool surface.

FIG. 14 shows a conical tool surface meshed by the software.

FIG. 15 shows two of the commonly used fiber start orientations 0° and 90° on a planar surface. A hypothetical bump illustrated by the red dot pushed the fibers off course, as shown by the blue dotted fiber.

FIG. 16 shows a coarse meshing of the tool surface and illustrates how fibers bend about the mesh lines to cover the tool surface.

FIG. 17 shows calculation of the angle between the overhanging fiber and the adjacent tool surface mesh next to be draped.

FIG. 18 shows draped meshes.

### DETAILED DESCRIPTION OF THE PREFERRED EMBODIMENTS

In accordance with the invention, it is contemplated that the amount of steering the graphite fiber ribbon will be calculated as a function of the width of the fiber ribbon and the shape of the object, or in many cases, a portion of the object to be formed during the particular winding segment being implemented.

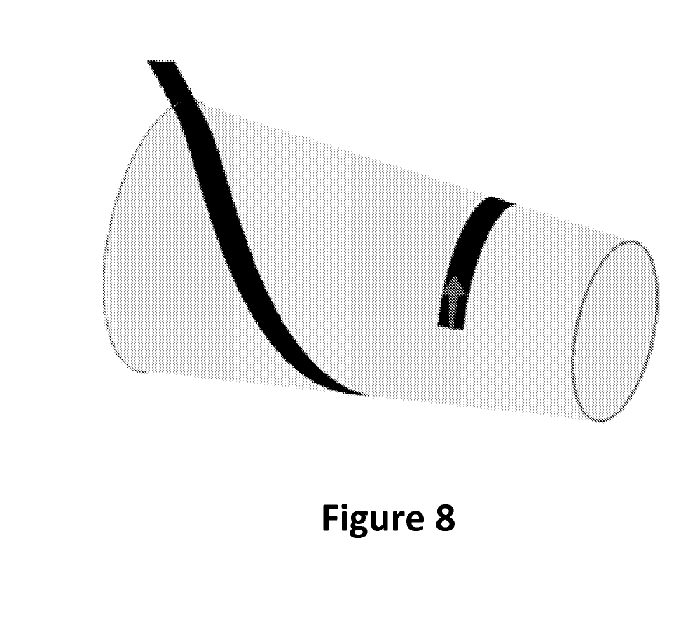

More particularly, manufacturers of graphite fiber ribbons, which are pre-wound for later immersion in resin and winding, specify the maximum radius of curvature which may be imparted to the fiber ribbon without damaging the fibers at the edge which is put under greater tension. For example, in winding the form illustrated in FIG. 8, the left edge of the ribbon must stretch to accommodate the largest conference and fantasy conference at the right edge of the ribbon.

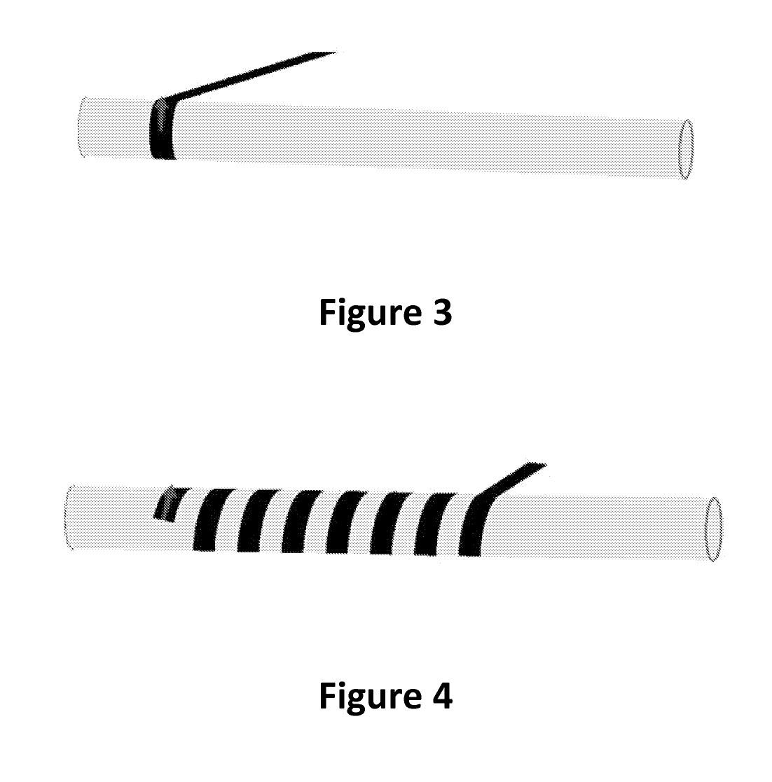

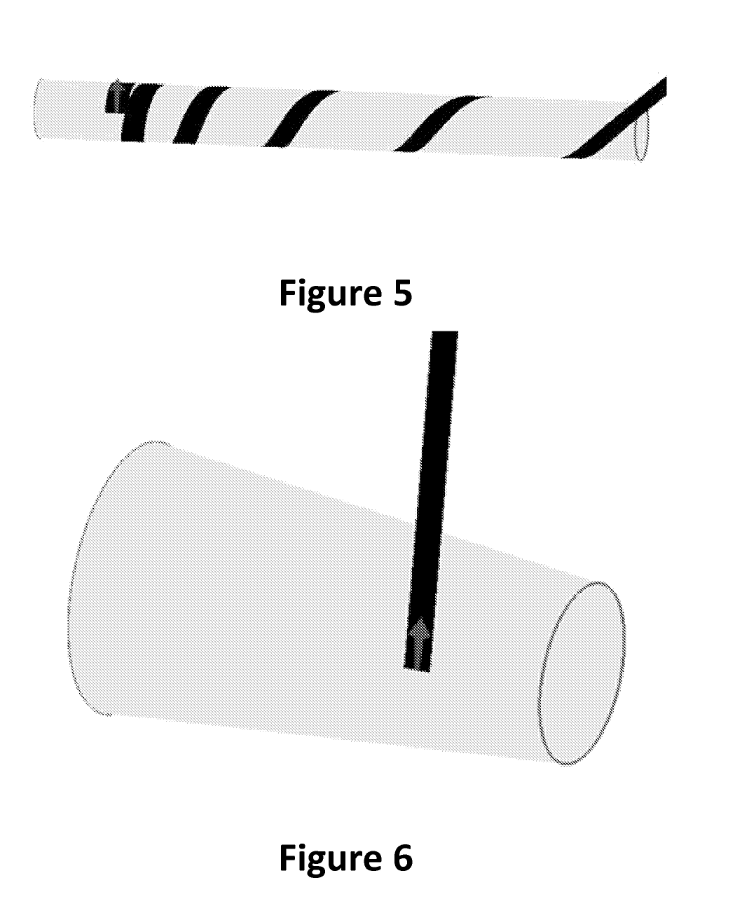

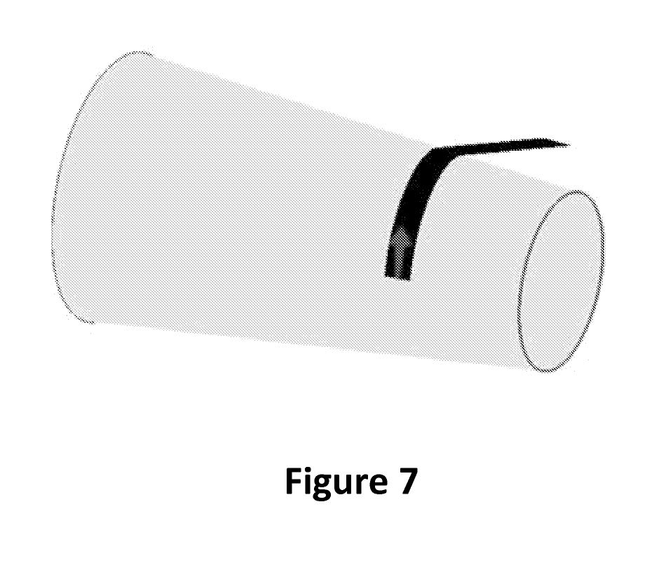

Generally, the maximum radius of bend or steering may be specified as the maximum radius in the plane of the flat ribbon. Bending in directions perpendicular to the plane of the flat fiber ribbon as no significant impact the fibers and does not affect quality. Thus, bending of the sort illustrated in FIG. 3, with the fiber is wrapped over a cylinder of uniform diameter with substantially no strain on the fibers and do not degrade the quality of the final product.

In accordance with the invention, computing device program with appropriate software is used to calculate the amount of steering needed to make a layup by wrapping the graphite fiber ribbon over the form during the formation of the entire part. While automatic machinery is used to do this work, there is no quality control, the judgments being made by experience. Hence, lower quality parts often result.

In accordance with the invention, the winding associated with the layout fabrication is modeled using a computer for a strip or ribbon of graphite fibers of a particular width. The model determines the angle of steering as a function of the position of the form, for example, the angular position of the form as it is rotated and the displacement of the ribbon along the axis of the form from a reference point on the axis and the radial distance from the point of contact between the ribbon and the form from the axis. The program then calculates the appropriate radius of steering and determines how many times and to what extent during the fabrication process steering has exceeded the manufacturer's recommended limits.

In the event that exceptionally high quality products are desired, the software may specify and insure that the manufacturers limits are never to be exceeded. Alternatively, it may be decided that limited magnitudes of excessive steering may be tolerated. Still another alternative is to limit the number of times and ordered the length of steering which exceeds the manufacturers limits. Alternatively, combinations of these two parameters may be used.

In accordance with the invention, fabrication of a layup using multiple layers of steered fiber ribbons may be formed wherein manufacturers limits are exceeded in one layer bought been overwound with fiber placed with a radius that does not exceed the manufacturers limits.

In accordance with the invention, it is steering data from a simulated winding of a layup exceeds the set standard, proceeds to model the winding of the layup with a ribbon of smaller width. The software may initially make relatively large changes in the width of the model followed by smaller changes, optionally including increases and decreases in with until the largest width fiber ribbon or strip which meets the specification has been determined. The use of larger width fiber strips or ribbons is preferred because this reduces manufacturing time.

Still yet another possibility is to marry the shape of a part being manufactured to accommodate the use of relatively wide ribbons of graphite fiber.

In accordance with the invention, the manufacturing may be reputedly modeled, by also marrying the amount of overlap or gaps in one or multiple layers. Here again, acceptable specifications for overlap and gaps are input into the system.

The invention also recognizes that some degree of stretching is achievable by angularly rotating the feed head which pays out the graphite fiber ribbon. This causes sliding of the graphite fibers with respect to each other. In this manner, the strains put on the fibers by steering may be wholly or partially avoided. In accordance with the invention, during the winding, for example, of the top of an airplane wing, such sliding of fibers with respect to each other may be implemented. The modeling may then direct that as the form continues to be rotated, manufacturers specifications and or wrinkling or over wrapping may be implemented on the reverse side of the form, as required to result in the placement and orientation of the feeder head in a manner that accommodates formation of the layup in accordance with the parameters specified. That part of the graphite fiber layup wound over the reverse side of the form, after killing of the resin, may be cut away in conventional fashion leaving a formed and substantially finished desired part within the specification. This additional degree of freedom may be used to increment toward an acceptable model for formation/winding up the layup.

In accordance with the invention, the modeling may also vary the shape, dimension and features, and their positions, of the part which forms the reverse of the layup, because the graphite formed on the reverse of the layout will be discarded. Thus, the reverse of the layup may be adjusted in dimension, position, shape and configuration as is necessary to reduce the radius of bending during layup winding.

Still yet another possibility under the invention is to vary the shape of the reverse of the form during winding. Thus winding may be begun with one form, and then the form may be varied by the addition of a part or parts onto the reverse of the form which are position, configured and dimension to achieve the desired change in the orientation and position of the graphite fiber strip, so as to accommodate demanding specifications with respect to minimizing the amount of radius imparted during winding of the graphite fiber strip to form the layup.

It is yet further anticipated in accordance with the invention that the winding described above may be replaced by any fiber ribbon placement technique which is simulated mathematically in the computer.

According to the invention during such simulation of winding and other fiber placement systems, the stress causing changes in radius are calculated and parameters of the system are adjusted until the desired specifications met.

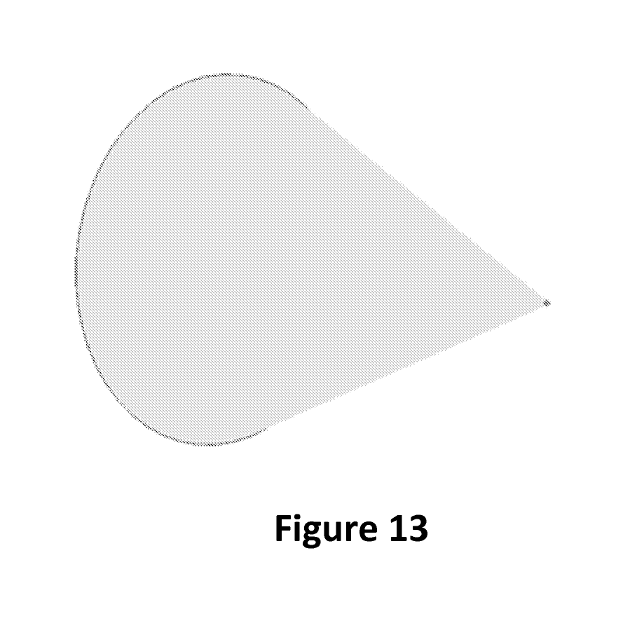

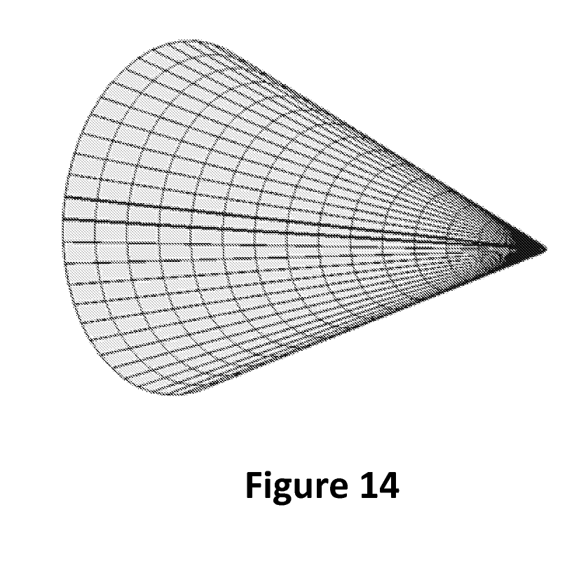

Software methodology. Meshing of the tool or mould surface is an important first step. The meshing must be performed such that the mesh lines are continuous along the mould surface. To demonstrate continuous mesh slices consider the cone depicted in FIG. 13. The cone is characterized by having a wide base converging to a pointed end. The cone is meshed such that all mesh lines or slices that start from the base of the cone terminate at the pointed opposite end, FIG. 14. Hence, spacing between mesh lines may not be constant and each resultant pixel bordered by the meshing lines may have differing surface area, especially as complex 3D moulds are modeled. The mould/tool in FIG. 14 is coarsely meshed for illustration and each pixel is a planar/flat surface. In actual simulations the pixel surface area will decrease as surface meshing density increase and the modeled tool surface definition will bear true resemblance to that of actual mould.

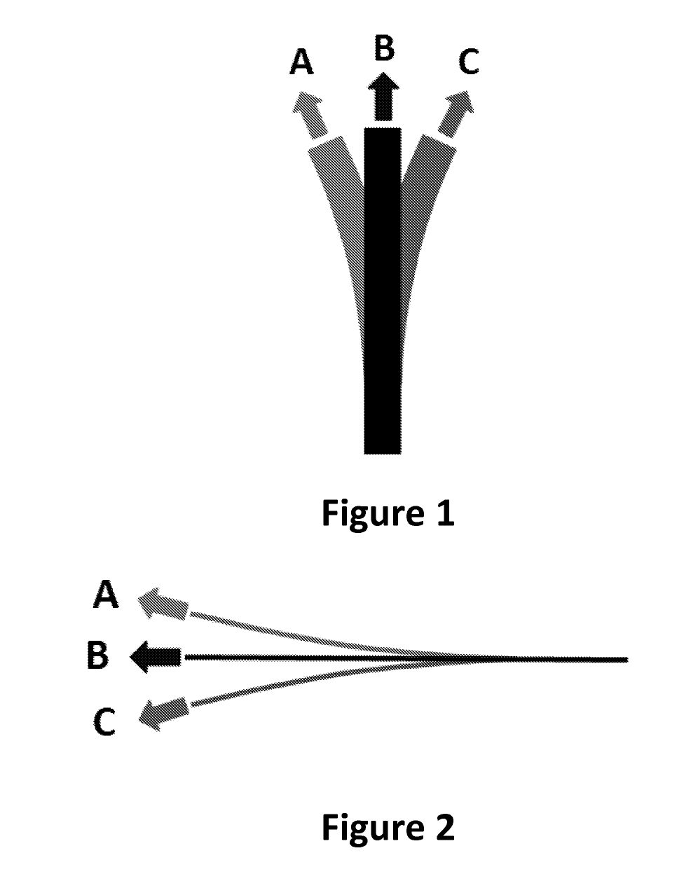

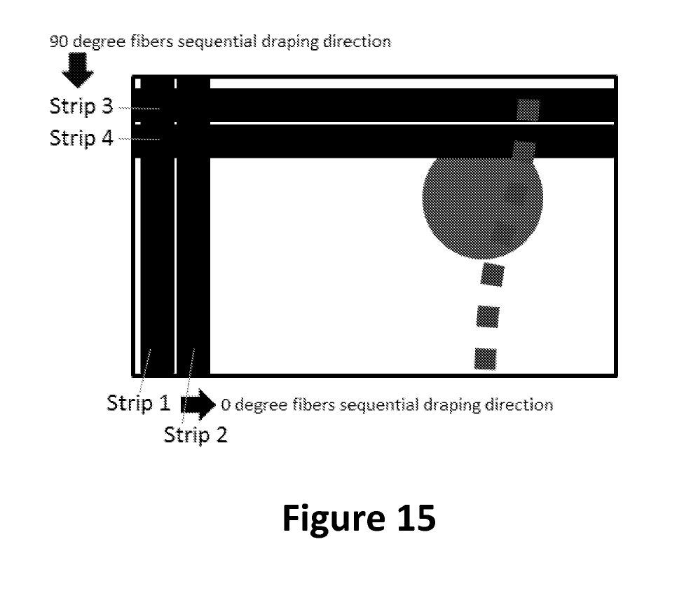

Tape/ribbon/fiber positioning. Usual AFP procedure is carried out by placing tapes from one side of the tool surface to the opposite side in a sequential approach. For example, consider a simple case of a planar surface, such as a table surface, as shown in FIG. 15. Assume Strip 1 and 2 represent 0° (zero degree) draping (note; more strips are needed to cover the surface entirely). Since a planar surface does not force fibers off the 0° line for natural draping pathway (i.e. no steer), the fibers arrive at the opposite side at 0°. Similarly, there will be no change of fiber direction for Strips 3 and 4 which represent the 90° (ninety degree) draping. However, if the surface contain an irregularity, e.g. a bump, depicted by the red dot on the planar surface in FIG. 15, then the fibers will be forced off line as the fibers encounter these irregularities, and fibers may not arrive at the opposite side at the initial orientation, resulting in a new natural fiber pathway as shown by the dotted blue fiber, FIG. 15. The cylindrical bar in FIG. 3 is considered to be regular tool surface, e.g. for 0° draping, since the fibers are not deviated off the 0° pathways, whereas in FIG. 8 the offset of roughly 45° of the 0° fiber is as a result of the added convolution of the tool surface. It is therefore inevitable that when dealing with bicubic tool surfaces, adjacent fibers, such as Strip 1 and 2 of FIG. 15, will either or both overlap or leave gaps under their natural pathways (i.e. when no steering is present, refer to FIG. 1) when traversing from their starting position to opposite end. Steering and adjusting tape drape start direction are used to eliminate the gaps or overlaps between adjacent tapes. Commonly used tape orientations are 0° (zero degree), 45° (forty five degree) and 90° (ninety degree) for each layer applied in succession to enhance the overall strength of the part manufactured.

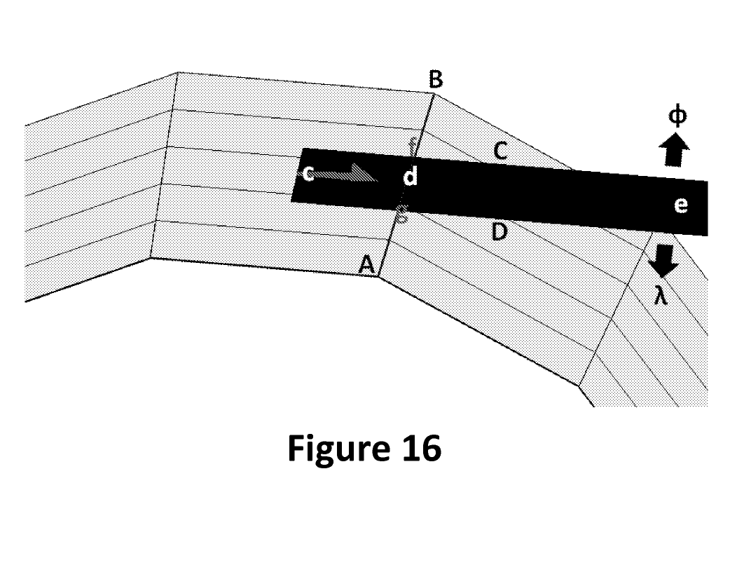

Calculation of fibers natural pathway. The core of the Finite Element Modeling (FEM) bends the fibers about the mesh lines to calculate fiber orientation and remaining fiber length for draping. Consider FIG. 16 with enlarged mesh pixel surfaces to aid visualization. The fiber segment ‘cd’ lies and covers the mesh surface/s that surround the fiber segment.

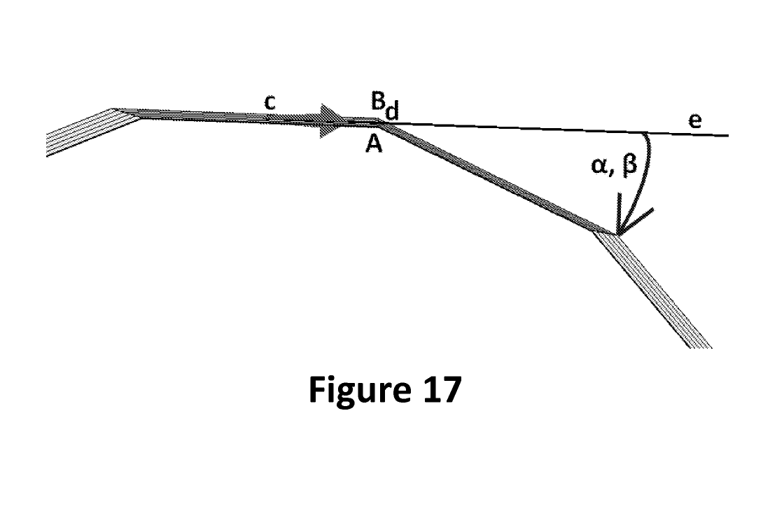

The two angles α and β between the overhanging fiber side ‘C’ and ‘D’ respectively and the adjacent mesh are calculated, FIG. 17.

For a conical, cylindrical or most simple moulds the ‘α’ and ‘β’ values will be equal. However, for most bicubic objects, such as a sphere, and moulds with complex curvature, the ‘α’ and ‘β’ values will differ. The overhanging fiber ‘de’ is rotated by the minimum value of ‘α’ and ‘β’ about the mesh line ‘AB’, FIG. 17.

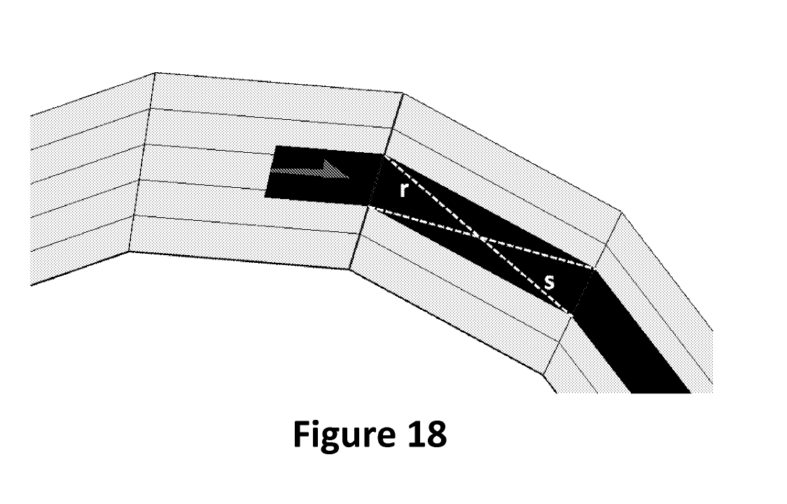

Since both fiber side ‘C’ and ‘D’ must be in contact with the tool/mould surface, when ‘α’ and ‘β’ values differ then the residual rotation, (α−β) if α>β or (β−α) if β>α, is performed about the dashed white lines ‘r’ and ‘s’, FIG. 18. The fiber placement technology is used, e.g. as opposed to covering mould surfaces with complete sheet of carbon material, to ensure wrinkle free and complete coverage of mould surfaces with minimum material strain. Therefore, the fiber width is calculated such that the mould mesh surface curvature under fiber is usually linear.

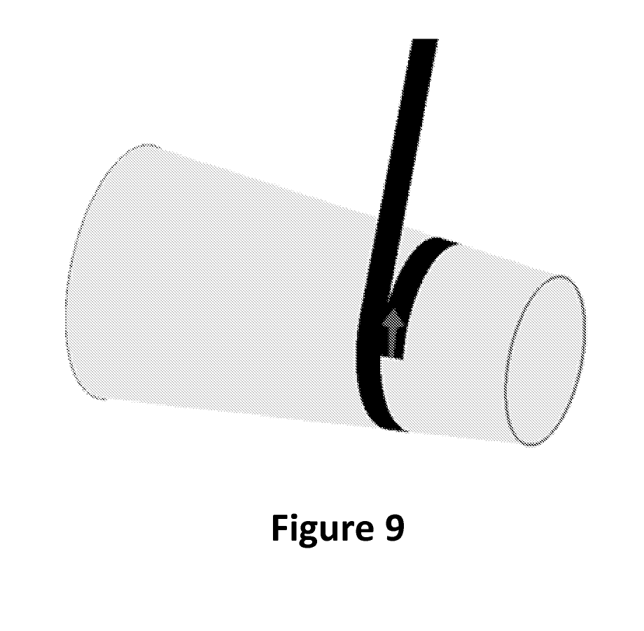

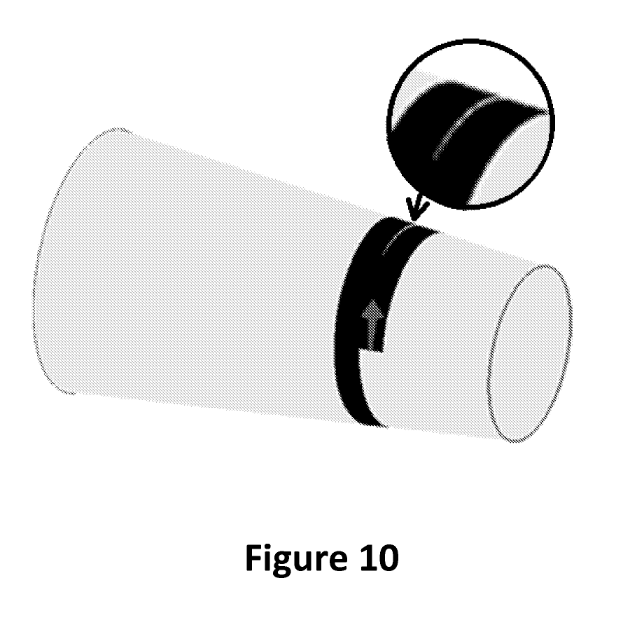

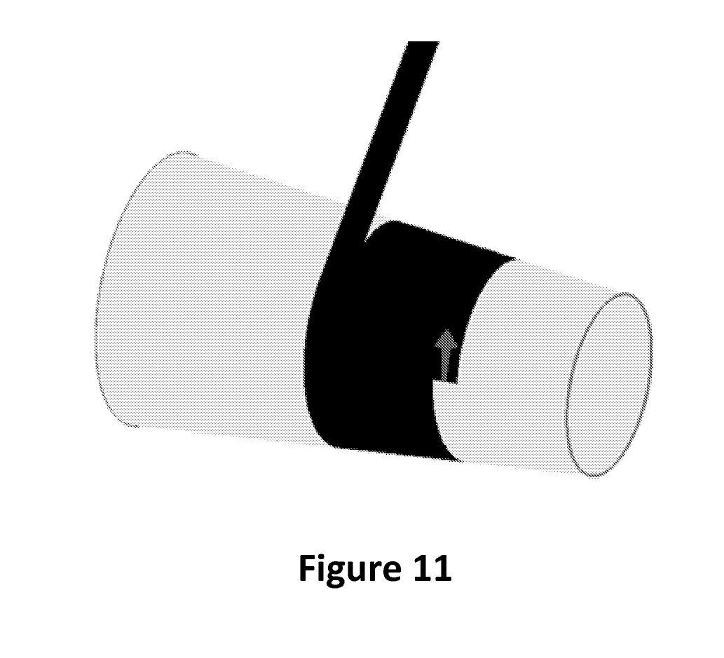

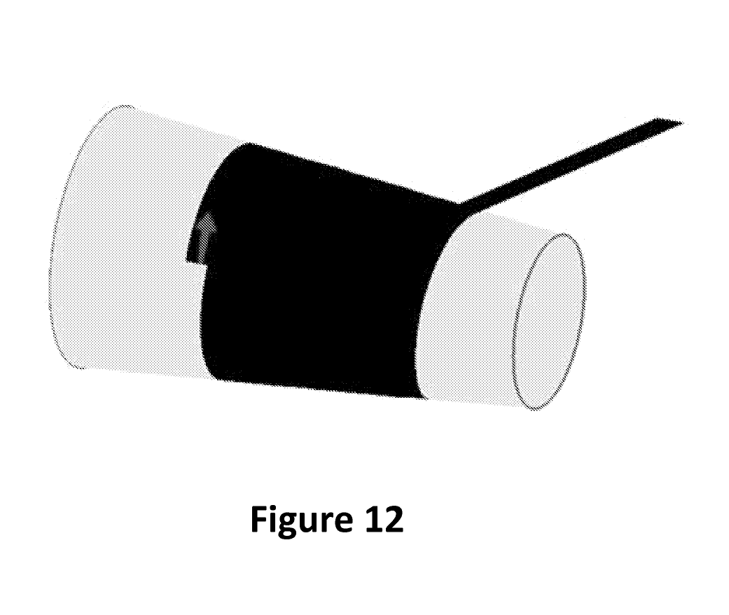

Fiber steering. The bicubic nature of mould surface will result in fibers with complicated offset from the straight 0°, 45° and 90° draping directions. These offsets can be eliminated by bending the fiber segment ‘de’ at point ‘d’ on plane containing the segment ‘cd’ by an incremental value φ or λ, FIG. 16. For example, the gap in FIG. 8 is closed by calculating the offset on mesh line ‘AB’ between point ‘f’ and subsequent fiber contact with line ‘AB’ and calculating the incremental angle required for steering/bending, giving FIG. 9. Similarly, the gap observed after fiber passes the mesh line ‘AB’, FIG. 10 inset, is eliminated by further steering, giving FIG. 11. If the steering amount is prohibitive then the software will stop draping and exit by prompting user, FIG. 12.

Overall steering of the fiber must be lowered to ensure minimum fiber internal strain. Therefore, the fiber initial drape orientation, FIG. 4, must also be accounted for in the analysis.

For moulds of complex curvature, as well as eliminating the gaps and overlaps, the steering must be averaged for all fibers used across entire layup to minimize the overall steering.

What is claimed:

1. A method for strip draping over complex 3D mould surface:
(a) By calculating strip pathway without any widthwise steer across fiber length, i.e demonstrate strip natural pathway
(b) Use widthwise steering defined by natural bending of the strip to cover tool surface without gaps or overlaps between adjacent fibers
(c) Adjust fiber initial drape direction to minimize steering of the strip
(d) Determining and reduction of local steer maxima that results from mould convolution and average out all the fiber steer over the mould surface
